(19) United States
(12) Patent Application Publication
(10) Pub. No.: US 2011/0237632 A1
(43) Pub. Date: Sep. 29, 2011

(54) ANTIFOULING COMBINATION COMPRISING 4-BROMO-2-(4- CHLOROPHENYL)-5-(TRIFLUOROMETHYL)-1H-PYRROLE-3-CARBONITRILE

(76) Inventor: Tony Mathilde Jozef Kempen, Kapellen (BE)

(21) Appl. No.: 13/132,821

(22) PCT Filed: Dec. 10, 2009
(86) PCT No.: PCT/EP2009/066796

§ 371 Date: Jun. 3, 2011

(30) Foreign Application Priority Data
Dec. 11, 2008 (EP) 08171273.9

(51) Int. Cl. A01N 43/80; A01P 1/00

(52) U.S. Cl. 514/373

(57) ABSTRACT

The present invention relates to combinations of 4-bromo-2-(4-chloro-phenyl)-5-(trifluoromethyl)-1H-pyrrole-3-carbonitrile, or a salt thereof, and the biocidal compound 2-butyl-1,2-benzisothiazol-3(2H)one (butylBIT), or a salt thereof, which provide an improved protecting effect against fouling organisms. More particularly, the present invention relates to compositions comprising a combination of 4-bromo-2-(4-chlorophenyl)-5-(trifluoromethyl)-1H-pyrrole-3-carbonitrile, or a salt thereof, together with the biocidal compound butylBIT; in respective proportions to provide a synergistic effect against fouling organisms and the use of these compositions for protecting materials against fouling organisms.

The present invention relates to combinations of 4-bromo-2-(4-chloro-phenyl)-5-(trifluoromethyl)-1H-pyrrole-3-carbonitrile, or a salt thereof, and the biocidal compound 2-butyl-1,2-benzisothiazol-3(2H)one (butylBIT), or a salt thereof, which provide an improved protecting effect against fouling organisms. More particularly, the present invention relates to compositions comprising a combination of 4-bromo-2-(4-chlorophenyl)-5-(trifluoromethyl)-1H-pyrrole-3-carbonitrile together with the biocidal compound butylBIT, or the salts thereof; in respective proportions to provide a synergistic effect against fouling organisms and the use of these compositions for protecting materials against fouling organisms.

It has now been found that the combination of 4-bromo-2-(4-chloro-phenyl)-5-(trifluoromethyl)-1H-pyrrole-3-carbonitrile (hereinafter referred to as component I) and the biocidal compound 2-butyl-1,2-benzisothiazol-3(2H)one (butylBIT) (hereinafter referred to as a component II), has a synergistic effect on the control of fouling organisms. As used herein, “control” is defined to include the inhibition of attachment or settlement of fouling organisms to the surface of an object, the removal of fouling organisms that are attached to the surface of an object, and the growth of fouling organisms.

4-Bromo-2-(4-chlorophenyl)-5-(trifluoromethyl)-1H-pyrrole-3-carbonitrile, also known as tralopyril, is disclosed in EP-0,312,723 for controlling molluscs. Said compound can be represented by the formula:

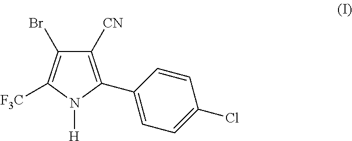

EP-0,746,979 describes the use of 4-bromo-2-(4-chlorophenyl)-5-(trifluoro-methyl)-1H-pyrrole-3-carbonitrile in antifoulant compositions which are applied to underwater surfaces in order to prevent the attachment of fouling organisms to said underwater surfaces. WO-03/039256 discloses combinations of 4-bromo-2-(4-chloro-phenyl)-5-(trifluoromethyl)-1H-pyrrole-3-carbonitrile with bethoxazin, DCOIT, tolylfluanid and dichlofluanid for protecting materials against fouling organisms.

Component (II) is butylBIT, also known as BBIT or Densil DN, has bactericidal and fungicidal properties as disclosed in Arzneimittel-Forschung, vol. 14, p. 1301 (1964). It is the generic name of 2-butyl-1,2-benzisothiazol-3(2H)one which compound can be presented by the formula:

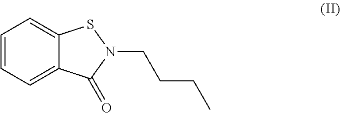

Wherever the term “4-bromo-2-(4-chlorophenyl)-5-(trifluoromethyl)-1H-pyrrole-3-carbonitrile”, “tralopyril”, component (I), “2-butyl-1,2-benzisothiazol-3(2H)one”, “butylBIT” or component (II) is used throughout this text, it is meant to include said compound both in base or in salt form, the latter being obtained by reaction of the base form with an appropriate acid. Appropriate acids comprise, for example, inorganic acids, such as the hydrohalic acids, i.e. hydrofluoric, hydrochloric, hydrobromic and hydroiodic, sulfuric acid, nitric acid, phosphoric acid, phosphinic acid and the like; or organic acids, such as, for example, acetic, propanoic, hydroxyacetic, 2-hydroxypropanoic, 2-oxopropanoic, ethanedioic, propanedioic, butanedioic, (Z)-2-butenedioic, (E)-2-butenedioic, 2-hydroxybutanedioic, 2,3-dihydroxybutanedioic, 2-hydroxy-1,2,3-propanetricarboxylic, methanesulfonic, ethanesulfonic, benzene-sulfonic, 4-methyl-benzenesulfonic, cyclohexanesulfamic, 2-hydroxybenzoic, 4-amino-2-hydroxybenzoic and the like acids. Said component (I) may also exist in the form of solvates, such as hydrates.

Surfaces or objects exposed to humid or aqueous environments are readily colonized by aquatic organisms such as algae, fungi, bacteria, microbes, and aquatic animals such as, e.g. tunicates, hydroids, bivalves, bryozoans, polychaete worms, sponges, barnacles, and molluscs. As these organisms settle on or attach to said surfaces, the value of the exposed objects diminishes. The attachment or settlement of said organisms is also known as ‘fouling’ of a structure. The exterior, but possibly also the interior of the object may deteriorate, the surface changes, e.g. from smooth, clean and streamlined to rough, foul and turbulent, the weight of the object increases by the deposit of the organisms and their remnants, and the vicinity of the object may become obstructed or encumbered. The function of the object and system involved lowers and the quality of the aqueous environment deteriorates. The common method of controlling the attachment of fouling organisms is by coating the structure to be protected with a composition which comprises an antifouling agent.

The combinations as claimed in the present invention are especially suitable to protect surfaces or objects in constant or frequent contact with water from fouling or attachment or settlement of algae, by applying to said surfaces or objects a composition comprising component (I) and one of the components (II) in respective proportions to provide a synergistic effect against fouling organisms.

Examples of said surfaces or objects are for instance, shiphulls, harbor installations, piers and pilings, drying docks, sluice-gates, locks, mooring masts, buoys, offshore oil rigging equipment, drilling platforms, bridges, pipelines, fishing nets, cables, ballast water tanks, ship reservoirs that draw water from infested bodies of water, recreational equipment, such as surfboards, jet skis, and water skis, and any other object in constant or frequent contact with water.

The invention also provides a method to protect materials, in particular surfaces or objects in frequent or constant contact with water, against fouling organisms by applying to said objects a composition comprising an effective antifouling amount of a combination of component (I) together with one of the components (II) wherein the amount of component (I) and component (II) are in respective proportions to provide a synergistic effect against fouling organisms. An “antifouling effective amount” is that amount that will kill or inhibit the growth, reproduction or spread of a significant number of fouling organisms.

The present invention further provides a method of protecting a surface which comprises applying to the surface a composition comprising an effective antifouling amount of a combination of component (I) together with one of the components (II) wherein the amount of component (I) and component (II) are in respective proportions to provide a synergistic effect against fouling organisms. An especially important use of the method of the invention comprises a method for inhibiting fouling of a ship's hull, which comprises applying to the hull an antifouling composition in accordance with the invention. Fouling on the hulls of ships for example increases frictional drag with a corresponding decrease in speed and maneuverability and an increase in fuel consumption and increased maintenance costs associated with removal of the fouling.

The compositions comprising a combination of component (I) together with one of the components (II) wherein the amount of component (I) and component (II) are in respective proportions to provide a synergistic effect against fouling organisms can be used to protect constructions such as, e.g. swimming pools, baths, cooling water circulation circuits and industrial baths in various installations, e.g. in manufactu-ring plants or in air-conditioning installations, the function of which can be impaired by the presence and/or the multiplication of fouling organisms. Further examples are buildings and parts of buildings such as floors, outer and inner walls or ceilings, or places suffering from dampness such as cellars, bathrooms, kitchens, washing houses and the like, and which are hot-beds for fouling. Fouling not only is problematic from the viewpoint of hygiene and aesthetics, but also causes economic losses because said buildings and/or decorating materials deteriorate more rapidly than desired.

Another application of the combinations of the present invention is the treatment or disinfection of ballast water to reduce or eliminate the presence of aquatic organisms such as phytoplankton (dinoflagellates and diatoms), crustaceans (crabs, shrimp, copepods, amphipods), rotifers, polychaetes, mollusks, fish, echinoderms, ctenophores, and coelenterates.

The synergistic antifouling compositions of the present invention can also be used in a variety of applications:
industrial aqueous process fluids, e.g. cooling waters, pulp and paper mill process waters and suspensions, secondary oil recovery systems, spinning fluids, metal working fluids, and the like
in-tank/in-can protection of aqueous functional fluids, e.g. polymer emulsions, water based paints and adhesives, glues, starch slurries, thickener solutions, gelatin, wax emulsions, inks, polishes, pigment and mineral slurries, rubber latexes, concrete additives, drilling mud's, toiletries, aqueous cosmetic formulations, pharmaceutical formulations, and the like.

The term “fouling organisms” is meant to comprise organisms that attach, settle, grow on or adhere to various kinds of surfaces, in particular in humid or aqueous environments such as, marine waters, fresh waters, brackish waters, rain water, and also cooling water, drainage water, waste water and sewage. Fouling organisms are Algae such as, for example, Microalgae, e.g. Amphora, Achnanthes, Navicula, Amphiprora, Melosira, Cocconeis, Chlamydomonas, Chlorella, Ulothrix, Anabaena, Phaeodactylum, Porphyridium; Macroalgae, e.g. Enteromorpha, Cladophora, Ectocarpus, Acrochaetium, Ceramium, Polysiphonia and Hormidium sp.; fungi; microbes; tunicates, including members of the class Ascidiacea such as Ciona intestinalis, Diplosoma listerianium, and Botryllus schlosseri; members of the class Hydrozoa, including Clava squamata, Hydractinia echinata, Obelia geniculata and Tubularia larynx; bivalves, including Mytilus edulis, Crassostrea virginica, Ostrea edulis, Ostrea chilensia, Dreissena polymorpha (zebra mussels) and Lasaea rubra; bryozoans, including Electra pilosa, Bugula neritina, and Bowerbankia gracilis; polychaete worms, including Hydroides norvegica; sponges; and members of the class Crustacea, including Artemia, and Cirripedia (barnacles), such as Balanus amphitrite, Lepas anatifera, Balanus balanus, Balanus balanoides, Balanus hameri, Balanus crenatus, Balanus improvisus, Balanus galeatus, and Balanus eburneus; and Elminius modestus, and Verruca.

The relative proportions of component (I) and component (II) in compositions comprising a combination of component (I) and (II) are those proportions which result in a synergistic effect against fouling organisms when compared to a composition including, as an active ingredient, either component (I) alone or component (II) alone. As will be understood by those skilled in the art, the said synergistic effect may be obtained within various proportions of components (I) and (II) in the composition, depending on the kind of fouling organism towards which effect is measured and the substrate to be treated. Based on the teachings of the present application, determination of the synergistic effect of such combinations can be performed according to the procedures of the Poison Plate Assay as described in Experiment 1. As a general rule, however, it may be said that for most fouling organisms the suitable proportions by weight of the amount of component (I) to component (II) in the combinations should lie in the range from 10:1 to 1:10. Particularly, this range is from 8:2 to 2:8, more particularly from 3:1 to 1:3 or 2:1 to 1:2. Another particular ratio of component (I) to component (II) in the compositions of the present invention is a 1:1 ratio between component (I) and component (II).

The quantity of each of the active ingredients in compositions comprising a combination of component (I) and component (II) will be so that a synergistic effect is obtained. In particular it is contemplated that the ready to use compositions of the present invention comprise component (I) in an amount of at least 1 wt % based on the total weight of the composition. In particular such ready to use compositions comprise component (I) in an amount from 1 wt % to 40 wt %, or more particular from 3 wt % to 30 wt %, based on the total weight of the composition. The amount of component (II) in said ready to use compositions will be so that a synergistic antifouling effect is obtained. In particular the amount of component (II) may range from 1 wt % to 30 wt %, more particular from 2 wt % to 20 wt % based on the total weight of the dry mass of the composition. In many instances the antifouling compositions to be used directly can be obtained from concentrates, such as e.g. emulsifiable concentrates, suspension concentrates, or soluble concentrates, upon dilution with aqueous or organic media, such concentrates being intended to be covered by the term composition as used in the definitions of the present invention. Concentrates used in the form of a paint composition can be diluted to a ready to use mixture in a spray tank shortly before use.

A composition comprising a combination of component (I) and component (II) in respective proportions to provide a synergistic effect against fouling organisms is thus suitably used together with carriers and additives, including wetting agents, dispersing agents, stickers, adhesives, emulsifying agents and the like such as those conventionally employed by the artisan in preparing antifouling compositions. The antifouling compositions of the present invention may further comprise suitable substances known in the art of formulation, such as, for example natural or regenerated mineral substances, solvents, dispersants, surfactants, wetting agents, adhesives, thickeners, binders, anti-freeze agents, repellents, colour additives, corrosion inhibitors, water-repelling agents, siccatives, UV-stabilizers and other active ingredients. Suitable surfactants are non-ionic, cationic and/or anionic surfactants having good emulsifying, dispersing and wetting properties. The term “surfactants” will also be understood as comprising mixtures of surfactants.

Antifouling compositions comprising a combination of component (I) and component (II) in respective proportions to provide a synergistic effect against fouling organisms may be prepared in any known manner, for instance by homogeneously mixing, coating and/or grinding the combination of active ingredients (i.e. component (I) and component (II)), in a one-step or multi-steps procedure, with the selected carrier material and, where appropriate, the other additives such as surface-active agents, dispersants, thickeners, binders, colour additives, corrosion inhibitors and the like.

Suitable carriers for solid formulations, such as dusts, dispersable or flowable powders, are any dispersant that does not adversely affect the active ingredients, for example, clays (for example, kaolin, bentonite, acid clay, and the like), talcs (for example, talc powder, agalmatolite powder, and the like), silicas (for example, diatomaceous earth, silicic acid anhydride, mica powder, and the like), alumina, sulfur powder, activated charcoal, and the like. These solid carriers may be used either singly or in combination of two or more species

Appropriate carriers for liquid formulations are any liquid that does not adversely affect the active ingredients, for example, water, alcohols (for example, methyl alcohol, ethyl alcohol, ethylene glycol, propylene glycol, diethylene glycol, glycerin, etc.), ketones (for example, acetone, methyl ethyl ketone, etc.), ethers (for example, dioxane, tetrahydrofuran, cellosolve, diethylene glycol dimethyl ether, etc.), aliphatic hydrocarbons (for example, hexane, kerosene, etc.), aromatic hydrocarbons (for example, benzene, toluene, xylene, solvent naphtha, methyl naphthalene, etc.), halogenated hydrocarbons (for example, chloroform, carbon tetrachloride, etc.), acid amides (for example, dimethyl formadide, etc.), esters (for example, methyl acetate ester, ethyl acetate ester, butyl acetate ester, fatty acid glycerin ester, etc.), and nitriles (for example, acetonitrile, etc.). These solvents may be used either singly or in combination of two or more species.

Emulsifiable concentrates of the antifouling compositions according to the present invention can also be obtained upon dilution of the combination of components (I) and (II) with at least a suitable organic solvent (i.e. a liquid carrier) followed by the addition of at least a solvent-soluble emulsifying agent. Solvents suitable for this type of formulation are usually water-immiscible and belong to the hydrocarbon, chlorinated hydrocarbon, ketone, ester, alcohol and amide classes of solvents, and they can be properly selected by those skilled in the art based on the solubility's of components (I) and (II) respectively. Emulsifiable concentrates usually contain, in addition to the organic solvent(s), from about 10 to 50% by weight of the combination of active ingredients, from about 2 to 20% of emulsifying agent(s) and up to 20% other additives such as stabilisers, corrosion inhibitors and the like. The combination of components (I) and (II) may also be formulated as a suspension concentrate, which is a stable suspension of the active ingredients in a (preferably organic) liquid intended to be diluted with water before use. In order to obtain such a non-sedimenting flowable product, it is usually necessary to incorporate therein up to about 10% by weight of at least a suspending agent selected from known protective colloids and thixotropic agents. Other liquid formulations like aqueous dispersions and emulsions, for example obtained by diluting a wettable powder or a concentrate (such as previously described) with water, and which may be of the water-in-oil or the oil-in-water type, also lie within the scope of the present invention.

The present invention also provides protective antifouling compositions, for instance in the form of paints, coatings or varnishes, comprising the said combination of components (I) and (II) together with one or more additives suitable for their formulation. The total amount of the combination of components (I) and (II) in such protective compositions may range from 2 to 10% (w/v). Suitable additives for use in said protective compositions are quite conventional in the art and include, for instance, at least an organic binder (preferably in aqueous form) such as an acrylic or vinyl-based emulsion or rosin compounds; mineral carriers such as calcium carbonate; surface-active agents such as previously described; viscosity regulators; corrosion inhibitors; pigments such as titanium dioxide; stabilisers such as sodium benzoate, sodium hexametaphosphate and sodium nitrite; mineral or organic colorants and the like. The ways of formulating such additives together with the component (I) and one or more components (II) of the present invention is also well within the knowledge of those skilled in the art. Such protective compositions may be used not only to cure and/or limit the damaging effects of fouling organisms but also in order to prevent deterioration to occur on materials that may be subjected to the harmful environment and effects of fouling organisms.

The antifouling compositions according to the present invention can be applied by a number of conventional methods, such as hydraulic spray, air-blast spray, aerial spray, atomising, dusting, scattering or pouring. The most appropriate method will be chosen by those skilled in the art in accordance with the intended objectives and the prevailing circumstances, namely the kind of fouling organism to be controlled, the type of equipment available and the type of material to be protected.

The combination of components (I) and (II) may be used as antifouling additives in polyurethanes that are submerged in a marine or offshore environment. For addition to cross-linked polyurethane, said combination of components (I) and (II) may be added to the polyol component before reacting it with the isocyanate component. For addition to melt-processed thermoplastic polyurethane, said combination of components (I) and (II) may be metered into the melt, for example at the injection point in an extrusion system. Alternatively, polymer granules or chips containing the antifouling additives in a concentrated form may also be produced. These can be blended with non-biocide containing polymer granules or chips and then further heat processed via extrusion.

Other potential uses of the combination of components (I) and (II) include the use thereof as antifouling additives in other polymers including but not limited to polyolefins, polyesters, PVC, silicones, acrylics, synthetic elastomers such as butadiene-styrene, styrene-isoprene and acrylonitrile-butadiene-styrene.

As previously indicated, the combination of components (I) and (II) is preferably applied in the form of compositions wherein both said ingredients are intimately admixed in order to ensure simultaneous administration to the materials to be protected. Administration or application of both components (I) and (II) can also be a “sequential-combined” administration or application, i.e. component (I) and component (II) are administered or applied alternatively or sequentially in the same place in such a way that they will necessarily become admixed together at the site to be treated. This will be achieved namely if sequential administration or application takes place within a short period of time e.g. within less than 24 hours, preferably less than 12 hours. This alternative method can be carried out for instance by using a suitable single package comprising at least one container filled with a formulation comprising the active component (I) and at least one container filled with a formulation comprising an active component (II). Therefore the present invention also encompasses a product containing:
(a) a composition comprising 4-bromo-2-(4-chloro-phenyl)-5-(trifluoromethyl)-1H-pyrrole-3-carbonitrile, or a salt thereof, as component (I), and
(b) a composition comprising 2-butyl-1,2-benzisothiazol-3(2H)one, or a salt thereof, as component (II),
as a combination for simultaneous or sequential use, wherein said (a) and (b) are in respective proportions to provide a synergistic effect against fouling organisms.

### EXPERIMENT

### Poison Plate Assay

### Experiment 1

### Poison Plate Assay

General procedure: to each well of a 24-well microtiter plate, 1990 μl BG11 medium containing the test compounds in one of the concentrations of a dose series is added. The liquid freshwater mineral medium is inoculated by adding an aliquot of an actively growing, 3 week old liquid BG11 culture of algae and incubated at 21° C., 65% relative humidity, 1000 Lux 16 hr/day. The growth is evaluated after two weeks.
Test compounds: 4-bromo-2-(4-chloro-phenyl)-5-(trifluoromethyl)-1H-pyrrole-3-carbonitrile as component (I) butylBIT as component (II);
Stock solution: 8000 and 80.000 ppm in DMSO

| % product A + | % product B |
|---|---|
| 100 + | 0 |
| 80 + | 20 |
| 66 + | 33 |
| 50 + | 50 |
| 33 + | 66 |
| 20 + | 80 |
| 0 + | 100 |

Test combinations:
Concentrations: 1.6-1.2-0.9-0.68-0.51-0.38-0.29-0.21-0.16-0.12-0.09-0.07 ppm
Culture medium: algae: BG 11 liquid mineral medium
Experimental set up: 24-well plates
Species of algae: Tribonema sp. CCAP880/2
Inoculum: algae: 1990 μl of a 1/10 dilution in BG 11 of a two week old culture
Culture conditions: 21° C., 65% relative humidity, 1000 lux, 16 hour photoperiod
Evaluation: algae: after 2 weeks of exposure

Synergism between component (I) and one of the components (II) was determined by a commonly used and accepted method described by Kull F. C. et al. in Applied Microbiology, 9, 538-541 (1961) using the Synergy Index, which is calculated as follows for two compounds A and B:

$$Synergy Index ( S I ) = \frac{{Q}_{a}}{{Q}_{A}} + \frac{{Q}_{b}}{{Q}_{B}}$$

wherein:
Q_{A} is the concentration of compound A in ppm, acting alone, which produced an end point (e.g. MIC),
Qₐ is the concentration of compound A in ppm, in the mixture, which produced an end point (e.g. MIC),
Q_{B} is the concentration of compound B in ppm, acting alone, which produced an end point (e.g. MIC),
Q_{b} is the concentration of compound B in ppm, in the mixture, which produced an end point (e.g. MIC).

MIC is the minimum inhibitory concentration, i.e. the lowest concentration of each test compound or mixture of test compounds sufficient to inhibit visible growth.

When the Synergy Index is greater than 1.0, antagonism is indicated. When the SI is equal to 1.0, additivity is indicated. When the SI is less than 1.0, synergism is demonstrated.

When the Synergy Index is greater than 1.0, antagonism is indicated. When the SI is equal to 1.0, additivity is indicated. When the SI is less than 1.0, synergism is demonstrated.

TABLE 1
MIC-values (minimum inhibitory concentration in
ppm) and synergy index of component (I) and (II) and
their combination against Tribonema sp.

| | | MIC-values in | synergy |
|---|---|---|---|
| Combination | ratio (I) to (II) | ppm | index |
| (I) + (II) | 100 + 0 | 2.10 | — |
| (I) + (II) | 80 + 20 | 0.90 | 0.43 |
| (I) + (II) | 66 + 33 | 0.90 | 0.43 |
| (I) + (II) | 50 + 50 | 0.90 | 0.43 |
| (I) + (II) | 33 + 66 | 0.90 | 0.43 |
| (I) + (II) | 20 + 80 | 1.20 | 0.57 |
| (I) + (II) | 0 + 100 | 2.10 | — |

1. A composition comprising a combination of 4-bromo-2-(4-chlorophenyl)-5-(trifluoromethyl)-1H-pyrrole-3-carbonitrile, or a salt thereof, as a component (I) together with 2-butyl-1,2-benzisothiazol-3(2H)one, or a salt thereof, as a component (II);
whereby component (I) and component (II) are in respective proportions to provide a synergistic effect against fouling organisms.

2. The composition according to claim 1 wherein the ratio by weight of component (I) to component (II) is 10:1 to 1:10.

3. The composition according to claim 2 wherein the ratio by weight of component (I) to component (II) is 3:1 to 1:3.

4. The composition as claimed in claim 1 wherein the amount of component (I) ranges from 1 wt % to 40 wt % based on the total weight of the composition.

5. (canceled)

6. A method of protecting materials against fouling organisms, wherein the said method comprises administration or application of an antifouling effective amount of a composition according to claim 1.

7. A method of disinfecting ballast water by adding an antifouling effective amount of a composition according to claim 1.

8. A product containing
(a) a composition comprising 4-bromo-2-(4-chloro-phenyl)-5-(trifluoromethyl)-1H-pyrrole-3-carbonitrile, or a salt thereof, as component (I), and
(b) a composition comprising 2-butyl-1,2-benzisothiazol-3(2H)one, or a salt thereof, as a component (II),
as a combination for simultaneous or sequential use, wherein said (a) and (b) are in respective proportions to provide a synergistic effect against fouling organisms.
